(19) United States
(12) Patent Application Publication
(10) Pub. No.: US 2008/0168665 A1
(43) Pub. Date: Jul. 17, 2008

(54) Swab cutter

(76) Inventor: Pang-Ching Chiang, Taipei (TW)

Correspondence Address: BACON & THOMAS, PLLC, 625 SLATERS LANE, FOURTH FLOOR, ALEXANDRIA, VA, 22314, US

(21) Appl. No.: 11/652,628

(22) Filed: Jan. 12, 2007

(51) Int. Cl. B26B 29/06

(52) U.S. Cl. 30/286

(57) ABSTRACT

The swab cutter has a body and a blade assembly. The body has an upper surface, a rear section, a front section, a cutting slot, a blade assembly slot and at least one detent. The cutting slot is formed in the front section. The blade assembly slot is formed vertically in the front section from the upper surface through the cutting slot and has two inside surfaces. The detent is formed in one of the inside surface. The blade assembly is mounted detachably in the blade assembly slot and has two sides, at least one resilient finger, a cutting slot and a blade. The resilient finger is formed respectively on one of the side of the blade assembly, and the finger has a boss corresponding to and selectively engaging the detent. The cutting slot corresponds to the cutting slot in the body. The blade is mounted in the cutting slot in the blade assembly.

### BACKGROUND OF THE INVENTION

1. Field of Invention

The present invention relates to a swab cutter, and more particularly to an orthopedic swab cutter that is convenient for users to hold, is easy for users to replace a blade assembly and will not wear down with repeatedly blade assembly replacements.

2. Description of the Related Art

Swab including a bandage is wrapped around a wound to protect the wound from infecting bacteria. Scissors are used to cut the swab when the swab needs to be removed or old swab needs to be replaced. However, orthopedic swab is made of a special fabric, so general-purpose scissors cannot cut the orthopedic swab smoothly. Moreover, when old swab is cut, general-purpose scissors may puncture skin around the swab. Thus, general-purpose scissors are not convenient and are not safe for users when removing orthopedic swab.

With reference to FIGS. 5 to 7, a conventional swab cutter is specialized to cut swab and has a body (50) and a detachable blade assembly (60).

The body (50) has an upper surface, a rear section, a front section, a front end, two sides, a hand hole (51), a cutting slot (52), a blade slot (53), a latch recess (54) and two detents (55). The hand hole (51) is defined transversely through the rear section to allow a person's fingers to extend through and hold the body (50). However, the hand hole (51) may not be large enough for some people to use and makes using the swab cutter inconvenient to use. The cutting slot (52) is formed longitudinally in the front section and has an open front end. The blade slot (53) is formed vertically in the front section of the body (50) from the upper surface through the cutting slot (52) and has a rear edge (56) and two inside surfaces. The rear edge (56) is slightly V-shaped. The latch recess (54) is defined transversely in the upper surface and communicates with the blade slot (53). The detents (55) are formed respectively in the inside surfaces of the blade slot (53) near the latch recess (54) and may be formed by a transverse hole passing through the body (50) and the blade slot (53).

The blade assembly (60) corresponds to and is mounted detachably in the blade slot (53) and has an inner edge (65), two sides, a latch tab (61), two bosses (62), a cutting slot (63) and a blade (64).

The inner edge (65) corresponds to the rear edge (56) of the blade slot (53) and engages the rear edge (56) of the blade slot (53) when the blade assembly (60) is mounted in the blade slot (53).

The latch tab (61) corresponds to the latch recess (54), engages the latch recess (54) when the blade assembly (60) is mounted in the blade slot (53) to prevent the blade assembly (60) from moving forward or backward and is used to pull the blade assembly (60) out of the blade slot (53) or press the blade assembly (60) into the blade slot (53).

The bosses (62) are formed on and protrude respectively from the sides of the blade assembly (60) and correspond respectively to and engage the detents (55) in the inside surfaces of the blade slot (53) to hold the blade assembly (60) in the blade slot (53). However, repeated removal and replacement of the blade assembly (60) causes the bosses (62) to wear grooves respectively in the inside surfaces of the blade slot (53) between the latch recess (54) and the detents (55). When the grooves wear deeply enough, the detents (55) no longer hold the bosses (62) and the blade assembly (60) easily and unintentionally detaches from the body (50).

The cutting slot (63) corresponds to the cutting slot (52) in the body (50) and has a lower edge. The blade (64) is mounted in the lower edge and protrudes into the cutting slot (52) of the body (50) to cut the swab.

To overcome the shortcomings, the present invention provides a swab cutter to mitigate or obviate the aforementioned.

### SUMMARY OF THE INVENTION

The primary objective of the present invention is to provide a swab cutter that is convenient for users to hold, is easy for users to replace a blade assembly and can be used repeatedly without wearing the swab cutter down.

To achieve the objective, the orthopedic swab cutter in accordance with the present invention has a body and a blade assembly. The body has an upper surface, a rear section, a front section, two sides, a handle, a cutting slot, a blade assembly slot and at least one detent. The rear section is a handle. The cutting slot is formed in the front section. The blade assembly slot is formed vertically in the front section from the upper surface through the cutting slot and has two inside surfaces. The detent is formed in one of the inside surface of the blade assembly slot. The blade assembly corresponds to and is mounted detachably in the blade assembly slot and has two sides, at least one resilient finger, a cutting slot and a blade. The resilient finger is formed on the sides of the blade assembly, and each of the at least one finger has a boss corresponding to and selectively engaging a corresponding detent. The cutting slot corresponds to the cutting slot in the body. The blade is mounted in the cutting slot in the blade assembly. Replacing the blade assembly is convenient for users, and the boss will not wear down.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a swab cutter in accordance with the present invention;

FIG. 2 is an explodes side view in partial section of the swab cutter in FIG. 1 with a hole defined in a body;

FIG. 3 is a side view in partial section of the swab cutter in FIG. 2;

FIG. 4 is a partial side view in partial section of the swab cutter in FIG. 3;

FIG. 5 is a perspective view of a conventional swab cutter in accordance with the prior art;

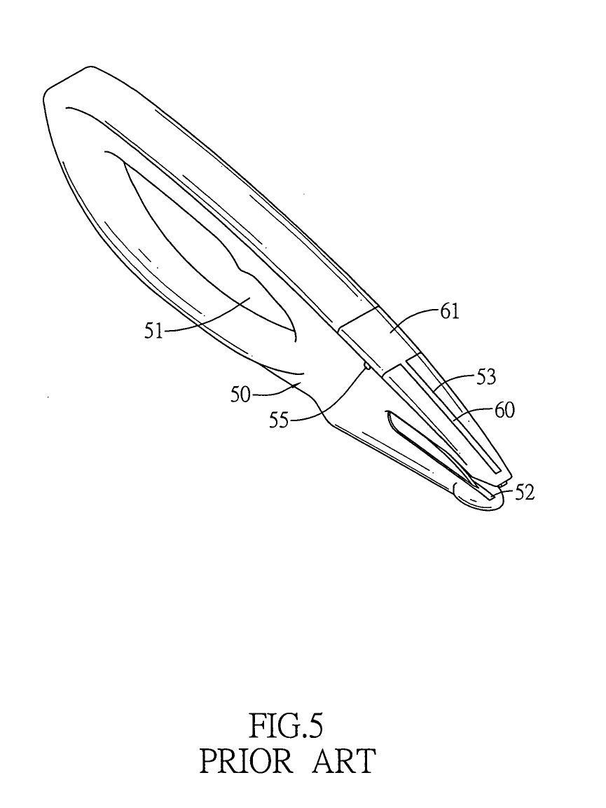

FIG. 6 is an exploded perspective view of the conventional swab cutter in FIG. 5; and

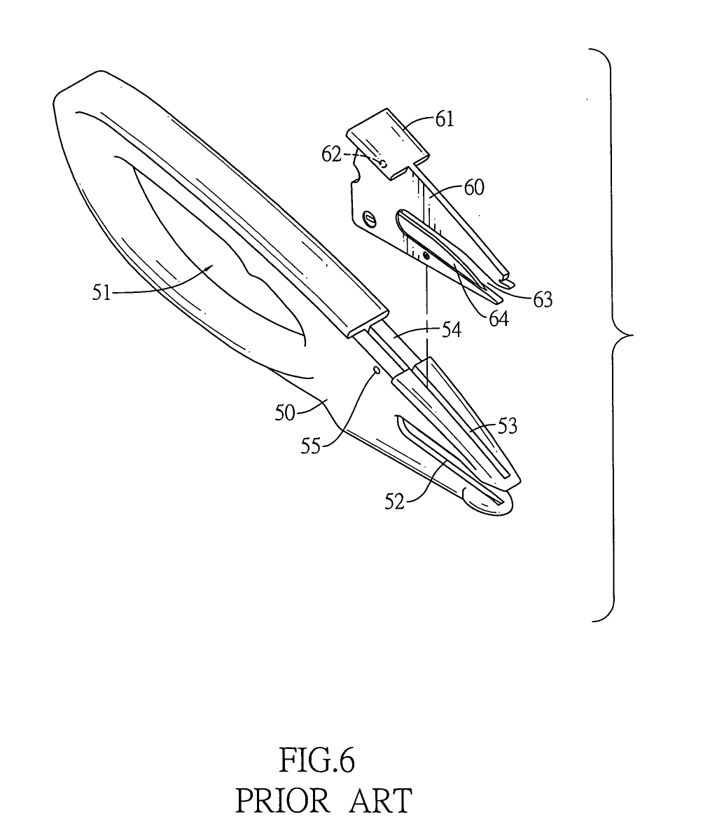

FIG. 7 is an exploded perspective view in partial section of the conventional swab cutter in FIG. 6.

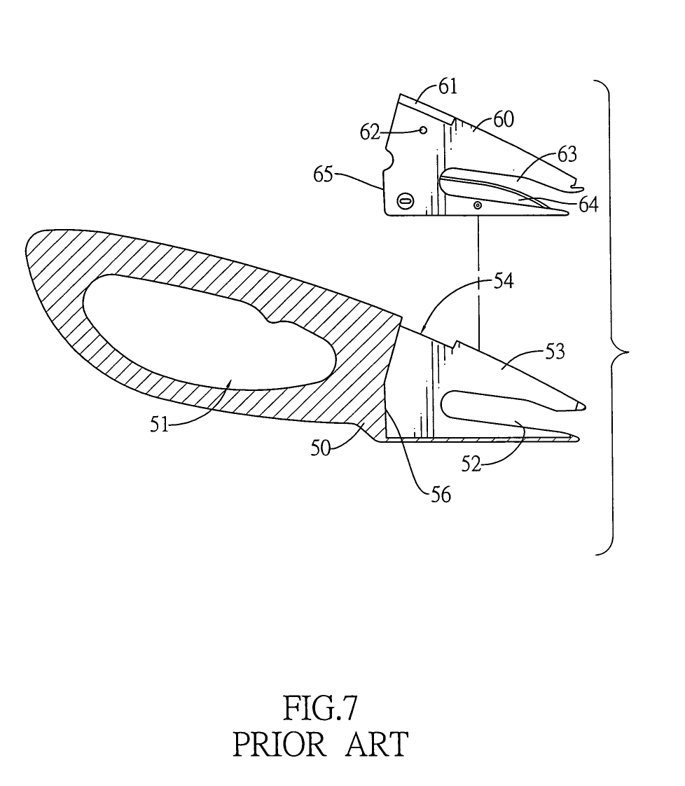

### DETAILED DESCRIPTION OF THE INVENTION

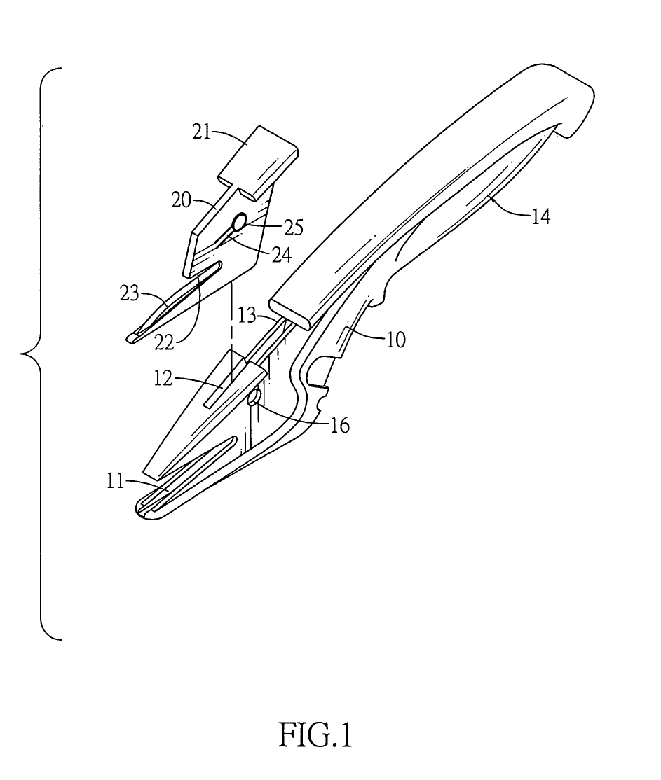

With reference to FIG. 1, a swab cutter in accordance with the present invention has a body (10) and a blade assembly (20).

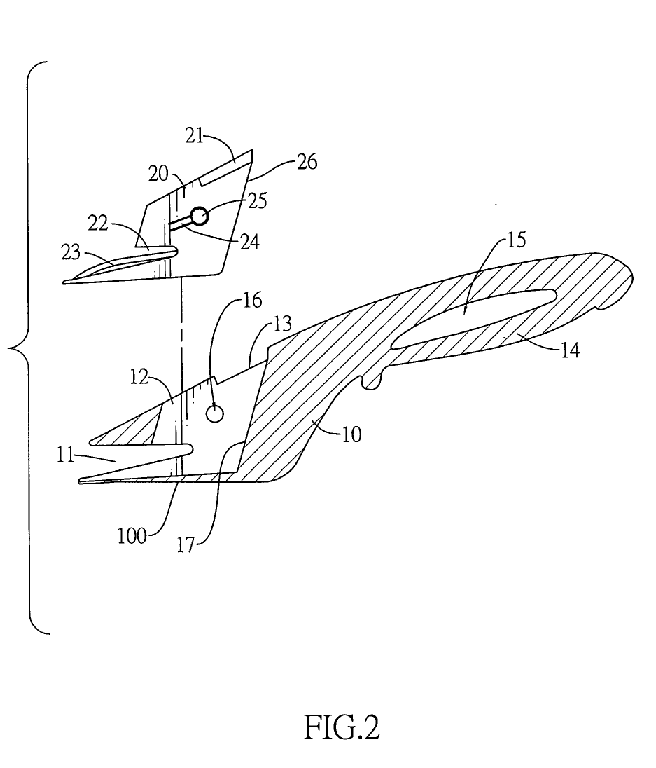

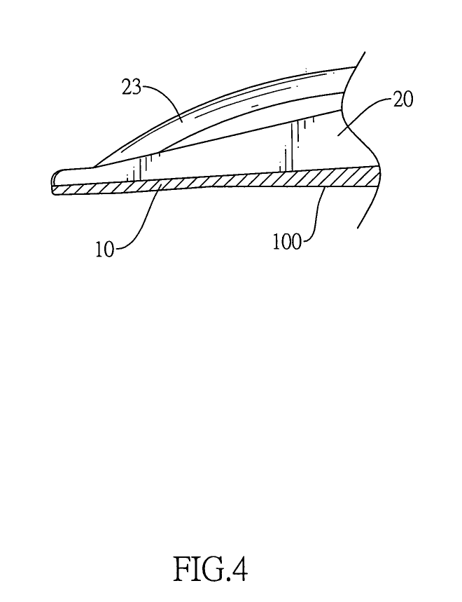

With further reference to FIG. 2, the body (10) has an upper surface, a rear section, a front section, two sides, a cutting slot (11), a blade assembly slot (12), a latch recess (13) and at least one detent (16). The rear section is a handle (14) to allow users to hold the swab cutter and has a vertical dimension. The handle (14) may be solid or have a hole (15). The hole (15) is defined transversely through the handle (14) to enlarge the vertical dimension of the handle (14). The front section has a bottom edge (100). With further reference to FIG. 4, the bottom edge (100) has a tapered front section and may have a medial bend. The tapered front section rests on and slides along a person's skin so the swab cutter can engage swab attached to the person's skin. The medial bend acts as a fulcrum to make cutting the orthopedic swab convenient for users. The cutting slot (11) is formed longitudinally in the front section and has an open front end. The open front end of the cutting slot (11) allows orthopedic swab attached to a person's skin to slide into the cutting slot (11). The blade assembly slot (12) is formed vertically in the front section from the upper surface through the cutting slot (11) and has two inside surfaces and a rear edge (17). The latch recess (13) is defined transversely in the upper surface and communicates with the blade assembly slot (12). The at least one detent (16) is formed in one of the inside surfaces of the blade assembly slot (12) near the latch recess (13) and may be formed by a transverse hole passing through the body (10) and the blade assembly slot (12).

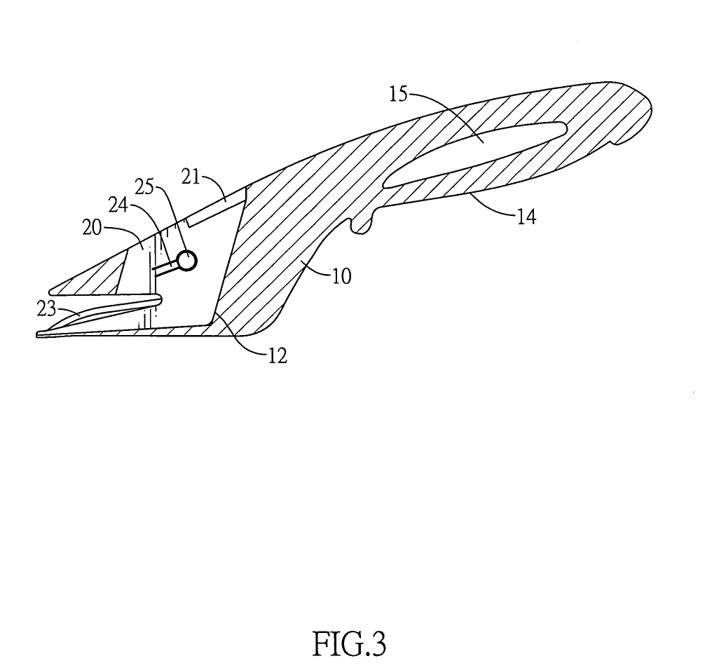

With further reference to FIG. 3, the blade assembly (20) corresponds to and is mounted detachably in the blade assembly slot (12) and has an inner edge (26), two sides, a latch tab (21), at least one resilient finger (24), a cutting slot (22) and a blade (23). The inner edge (26) corresponds to and abuts the rear edge (17) of the blade assembly slot (12) when the blade assembly (20) is mounted in the blade assembly slot (12). The latch tab (21) corresponds to the latch recess (13), engages the latch recess (13) to prevent from moving the blade assembly (20) forward or backward and is used to pull the blade assembly (20) out of the blade assembly slot (12) or press the blade assembly (20) into the blade slot (12). The at least one resilient finger (24) is formed on and protrudes at a slight angle from one of the sides of the blade assembly (20), and each of the at least one resilient finger (24) has a proximal end, a distal end and a boss (25). The proximal ends are formed respectively on the sides of the blade assembly (20). The boss (25) is formed respectively on and protrudes out from the distal ends of the resilient finger(24) and corresponds to and selectively engages the at least one detent (16) when the blade assembly (20) is mounted in the blade assembly slot (12) to hold the blade assembly (20) in the blade assembly slot (12). The cutting slot (22) corresponds to the cutting slot (11) in the body (10) and has an open front end and a lower surface. The open front end corresponds to the open front end of the cutting slot (11) in the body (10). The blade (23) is mounted in the lower surface of the cutting slot (22) in the blade assembly (20) and protrudes into the cutting slot (11) in the body (10) to cut orthopedic swab that is forced through the open front of the cutting slots (11, 22).

When installing or replacing a blade assembly (20), the blade assembly (20) is aligned with and pressed into the blade slot (12) by pressing the latch tab (21). The boss (25) presses against a corresponding side of the blade assembly (20) and presses the resilient finger (24) and boss (25) flush with the side until the boss (25) engage the detent (16) and the latch tab (21) seats in the latch recess (13) to the blade assembly (20) in place.

The blade assembly (20) is removed by pressing the boss (25) toward the sides of the blade assembly (20) and pulling up on the latch tab (21) until the boss (25) disengages from the detent (16). Thus, replacing the blade assembly (20) is convenient, and the boss (25) will not be worn down or wear the at least one detent (16) in the inside surfaces of the blade assembly slot (12).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A swab cutter comprising:
a body having
an upper surface;
a rear section being a handle;
a front section;
two sides;
a cutting slot being formed longitudinally in the front section and having an open front end;
a blade assembly slot being formed vertically in the front section from the upper surface through the cutting slot and having
two inside surfaces; and
a rear edge;
a latch recess being defined transversely in the upper surface and communicating with the blade assembly slot; and
at least one detent being formed in one of the inside surfaces of the blade assembly slot near the latch recess and communicating with the blade slot;
a blade assembly corresponding to and being mounted detachably in the blade assembly slot and having
an inner edge corresponding to and abutting the rear edge of the blade slot when the blade assembly is mounted in the blade assembly slot;
two sides;
a latch tab corresponding to the latch recess and engaging the latch recess;
at least one resilient finger being formed on and protruding at a slight angle from one of the sides of the blade assembly, and each of the at least one resilient finger having
a proximal end being formed on the sides of the blade assembly;
a distal end; and
a boss being formed on and protruding out from the distal end of the resilient finger and corresponding to and selectively engaging the detent when the blade assembly is mounted in the blade assembly slot;
a cutting slot corresponding to the cutting slot in the body and having
an open front end corresponding to the open front end of the cutting slot in the body; and
a lower surface; and
a blade mounted in the lower surface of the cutting slot in the blade assembly and protruding into the cutting slot in the body.

2. The swab cutter as claimed in claim 1, wherein the handle of the body is solid.

3. The swab cutter as claimed in claim 1, wherein the handle of the body has a hole defined transversely through the handle.

4. The swab cutter as claimed in claim 1, wherein the front section has a bottom edge having
a tapered front section; and
a medial bend being as a fulcrum.

5. The swab cutter as claimed in claim 1, wherein the detents are formed by a transverse hole passing through the body.
